(19) United States
(12) Patent Application Publication
(10) Pub. No.: US 2023/0144252 A1
(43) Pub. Date: May 11, 2023

(54) WASTE SORTING ROBOT

(71) Applicant: ZenRobotics OY, Helsinki (FI)

(72) Inventors: Tuomas Lukka, Helsinki (FI); Harri Holopainen, Espoo (FI); Esa Tirkkonen, Helsinki (FI); Viljami Maki, Helsinki (FI)

(21) Appl. No.: 17/798,775

(22) PCT Filed: Feb. 9, 2021
(86) PCT No.: PCT/FI2021/050088

§ 371 Date: Aug. 10, 2022

(30) Foreign Application Priority Data
Feb. 10, 2020 (SE) 2030043-0

(51) Int. Cl. B25J 9/00; B25J 9/02; B07C 5/36

(52) U.S. Cl. CPC B25J 9/0093; B25J 9/026; B07C 5/36; B25J 15/0616

(57) ABSTRACT

A waste sorting robot comprises: a frame and a manipulator moveably mounted to the frame and comprising a gripper for interacting with one or more waste objects to be sorted within a working area. The waste sorting robot comprises a conveyor for moving the one or more waste objects towards the working area. At least a portion of the manipulator is rotatable with respect to the frame such that the gripper is moveable lengthways along the conveyor within the working area.

The present invention relates to a waste sorting robot for sorting waste objects.

In the waste management industry, industrial and domestic waste is increasingly being sorted in order to recover and recycle useful components. Each type of waste, or “fraction” of waste can have a different use and value. If waste is not sorted, then it often ends up in landfill or incineration which has an undesirable environmental and economic impact.

Industrial waste may be passed to waste management centres because handling and disposing of waste is time consuming and requires specialist equipment. Accordingly, a waste management centre may sort waste to collect the most valuable and useful fractions. For example, industrial waste may include mixed wood and metal fractions (as well as other fractions) and sorted wood and metal fractions can be reused and sold to recyclers. Waste which is sorted into a substantially homogeneous fraction is more desirable and economical for recyclers. This is because less processing of the material is required before being recycled into new products and materials.

It is known to sort domestic and industrial waste in different ways. For many years waste has been manually sorted by hand on a conveyor belt. However hand sorting waste can be arduous and dangerous to the human sorter depending on the type of industrial or domestic waste being sorted. Furthermore, some waste sorting plants which use human sorters require multiple shifts in order to increase the output of sorted waste.

One approach for improving the safety and the output of waste sorting is to automate one or more aspects of the waste sorting. The automation can comprise a controller sending control and movement instructions to a manipulator for interacting with the physical objects. The combination of a controller sending control instructions to a manipulator can also be referred to as a “robot”.

The working volume/area can also include chutes which are not part of the surface of a conveyor belt.

One known robot for automatic sorting of waste is a “gantry” robot. A gantry robot comprises a frame or gantry which engages the floor and bridges over a working area such as a conveyor belt. The gantry supports the weight of the manipulator and an object that the manipulator grips. The gantry robot comprises one or more axes of control which move in a straight line (e.g. linear). Normally the axes of control of a gantry robot are arranged at right angles to each other.

A gantry robot may pick objects from the conveyor belt and drop the picked objects into a chute. A chute comprises an opening which is in communication with a bin or another conveyor belt for receiving a particular fraction of waste. The picked objects placed in the bin or on the conveyor belt can then be moved to another location or step in waste processing. This means a picked object of a certain waste fraction is dropped into the corresponding chute. Known gantry robots may have a four or more chutes located at the four corners of the rectangular working space for receiving the different fractions.

One known waste sorting gantry robot is shown in international patent application PCT/FI2019/050318 which shows a waste sorting gantry robot with a manipulator moveable on the gantry frame in three orthogonal directions actuated with a servo for each orthogonal direction. The manipulator comprises a pair of jaws for gripping and sorting waste objects. Since the manipulator travels on the gantry frame, one or more servos must be moved as well as the manipulator in order that the manipulator can travel in three degrees of freedom. This increases the weight and the inertia of the manipulator when travelling in one of the orthogonal directions e.g. the x direction. This means that the frame must be sufficiently large to allow the manipulator to travel and accelerate to the correct speed when picking and sorting waste objects.

Examples of the present invention aim to address the aforementioned problems.

According to an aspect of the present invention, there is a waste sorting robot comprising: a frame; a manipulator moveably mounted to the frame and comprising a gripper for interacting with one or more waste objects to be sorted within a working area; and a conveyor for moving the one or more waste objects towards the working area; wherein at least a portion of the manipulator is rotatable with respect to the frame such that the gripper is moveable lengthways along the conveyor within the working area.

This means that the waste sorting gantry frame robot only needs to provide a single horizontal beam across the conveyor belt reducing the weight and complexity of the waste sorting robot. This is because the gantry frame of the waste sorting gantry frame robot 100 does not need to allow movement of the manipulator mounted on a horizontal beam with an X-axis servo. By reducing the complexity of the gantry frame, this means that installation of the waste sorting gantry frame robot on a picking line is simplified and can be achieved by a single person.

By using a suction gripper which pivots, the mass of the manipulator can be greatly reduced. Movement of the horizontal beam or the manipulator can be achieved with a limited angular movement. This means the inertia of the manipulator is reduced and the manipulator can be accelerated more quickly. This means that the manipulator can move faster and the speed of the conveyor belt 10 can be increased. Advantageously, by increasing the speed of the conveyor belt, the objects to be sorted on the conveyor belt are more singularized and less likely to be overlapping. This means that the manipulation and object recognition is easier. This increases the processing rate (e.g. tons/hour) because the number of objects per hour which is fed to the robot increases.

This means that the waste sorting robot is suitable for a working area with a limited available distance in the X-axis but scalable in the Y-axis. Furthermore, the particular arrangement is advantageous for a waste sorting robot. This is because a high precision of movement of the manipulator similar to conventional robotics is not required. This is because the waste objects deform or move on the conveyor belt and waste objects are successfully picked with the waste sorting robot discussed in reference to the Figures.

Optionally the portion of the manipulator is rotatable about an axis perpendicular to the longitudinal axis of the conveyor.

Optionally, the manipulator is moveably mounted on a cross beam over the conveyor.

Optionally the manipulator is slidable along the cross beam.

Optionally waste sorting robot comprises a servo for moving the manipulator along the cross beam.

Optionally the portion of the manipulator is pivotable with respect to the cross beam.

Optionally the portion of the manipulator is pivotally coupled to a carriage mounted to the cross beam.

Optionally a first pneumatic actuator is coupled to the portion of the manipulator and configured to rotate the portion of the manipulator with respect to the frame.

Optionally the first pneumatic actuator is coupled between the portion of the manipulator and the carriage.

Optionally a second pneumatic actuator is coupled to the gripper and configured to adjust the height of the gripper above the conveyor.

Optionally the gripper is a suction gripper.

Optionally the first pneumatic actuator, the second pneumatic actuator and/or the suction gripper are connected to a single pneumatic control system.

Optionally the manipulator and the cross beam rotate together.

Optionally the waste sorting robot comprises a plurality of manipulators rotatable with respect to the frame such that a grippers associated with each manipulator is moveable lengthways along the conveyor.

Optionally the plurality of manipulators are located along the length of the conveyor.

Optionally the plurality of manipulators are mounted on the same cross beam or the same frame.

Optionally the manipulator comprises an articulated arm with one or more pivoting joints.

Optionally each pivoting joint coupled to an associated actuator.

Optionally the manipulator comprises a plurality of linked articulated arms.

Optionally the waste sorting robot is a waste sorting gantry robot.

Optionally the frame comprises a cross-beam with a longitudinal axis and the longitudinal axis of the cross-beam is fixed with respect to the working area.

Optionally the manipulator comprises at least one pneumatic actuator coupled the manipulator and/or the gripper configured to adjust the height of the gripper with respect to the working area.

Optionally the manipulator/and or the gripper are slidable in a direction perpendicular to the working area to adjust the height of the gripper with respect to the working area.

Optionally the manipulator comprises at least one pneumatic actuator coupled the manipulator configured to slide the manipulator on the frame across the conveyor in the working area.

In a second aspect of the invention there is provided a method of controlling a waste sorting robot having a frame, a manipulator moveably mounted to the frame, and a gripper for interacting with one or more waste objects to be sorted within a working area; the method comprising: moving the one or more waste objects towards the working area with a conveyor; and rotating at least a portion of the manipulator with respect to the frame such that the gripper is moved lengthways along the conveyor within the working area.

In a third aspect of the invention there is provided a waste sorting robot comprising: a frame having a beam extending over a working area; a manipulator moveably mounted to the beam and comprising a gripper for interacting with one or more waste objects to be sorted within a working area; and a conveyor for moving the one or more waste objects towards the working area; wherein at least a portion of the manipulator or the cross beam is rotatable such that the gripper is moveable lengthways along the conveyor within the working area.

In a fourth aspect of the invention there is provided a waste sorting robot comprising: a frame; a manipulator moveably mounted to the frame and comprising a gripper for interacting with one or more waste objects to be sorted within a working area; and a conveyor for moving the one or more waste objects towards the working area; characterised in that the frame comprises a fixed cross beam arranged over the conveyor and the manipulator is slidable along the cross-beam; wherein at least a portion of the manipulator is rotatable with respect to a longitudinal axis of the cross beam perpendicular to a longitudinal axis of the conveyor such that the gripper is moveable lengthways along the longitudinal axis of the conveyor within the working area.

Various other aspects and further examples are also described in the following detailed description and in the attached claims with reference to the accompanying drawings, in which:

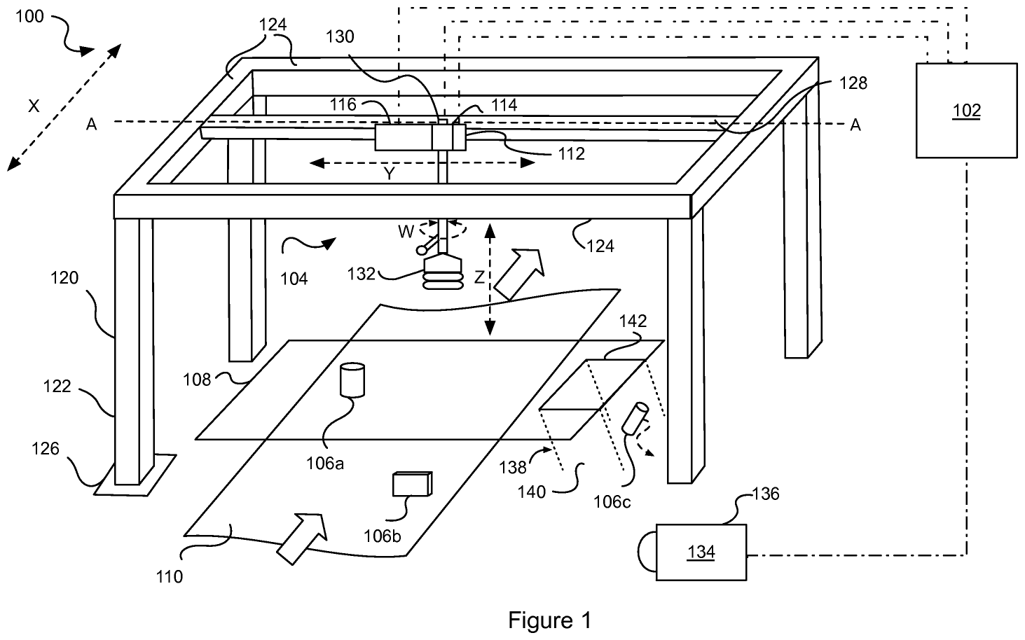

FIG. 1 shows a perspective schematic view of the waste sorting robot according to an example;

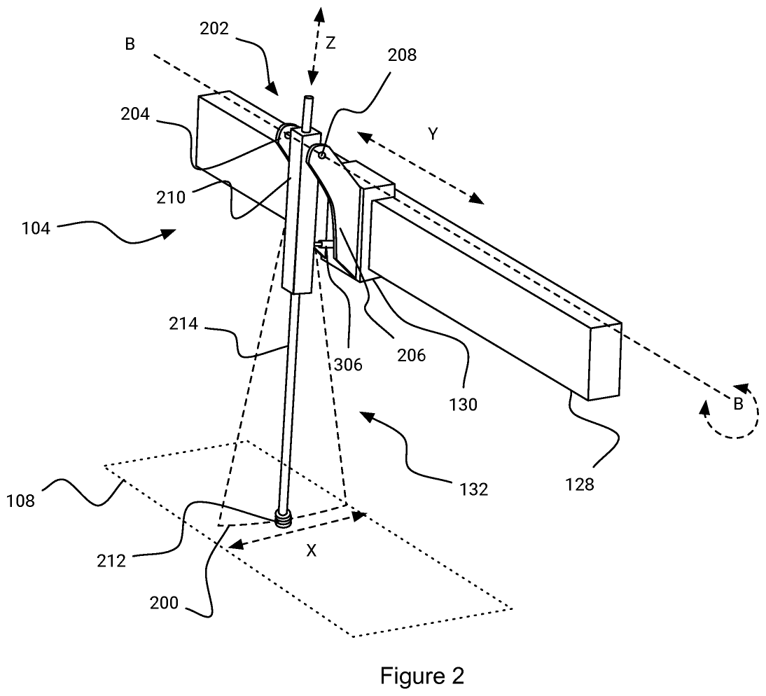

FIG. 2 shows a close-up perspective schematic view of a manipulator of the waste sorting robot according to an example;

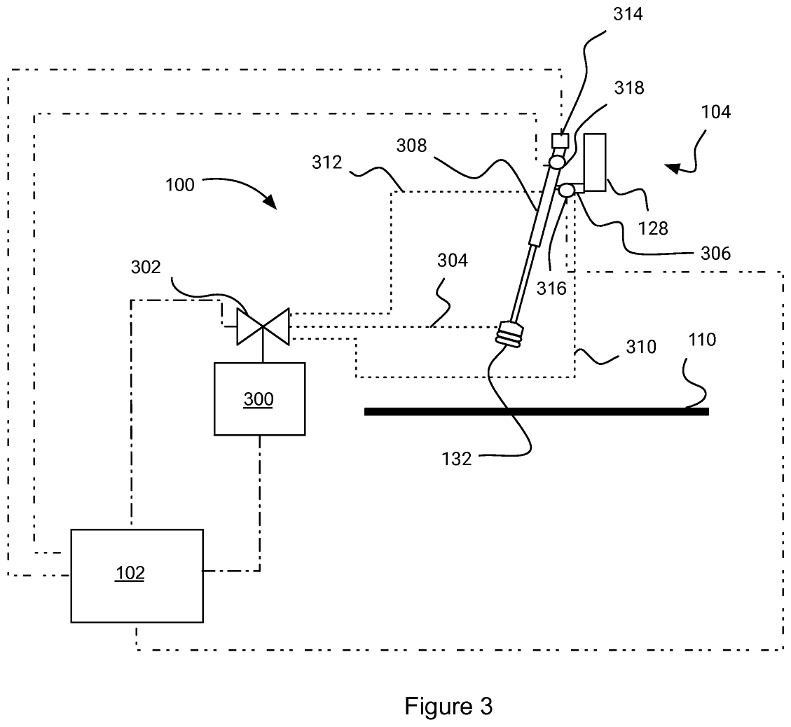

FIG. 3 shows a schematic view of the waste sorting robot and manipulator according to an example;

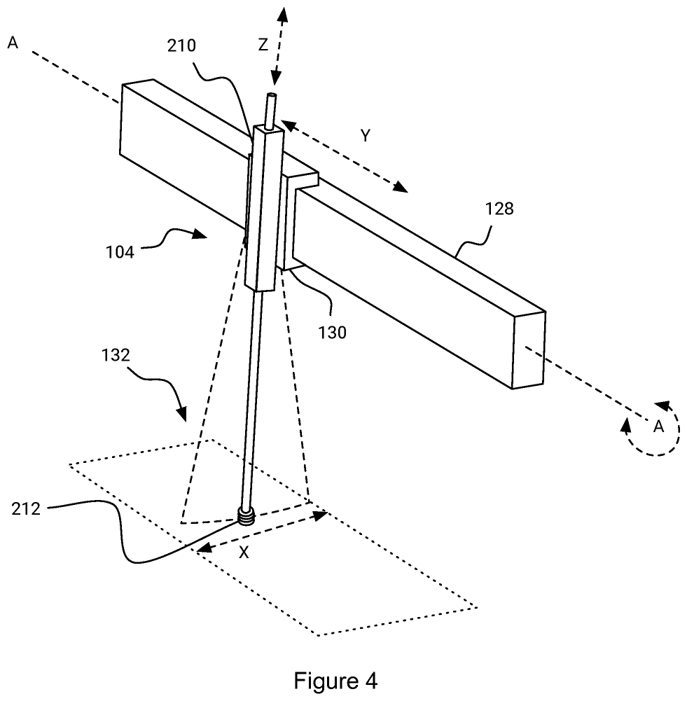

FIG. 4 shows another close-up perspective schematic view of a manipulator of the waste sorting robot according to an example;

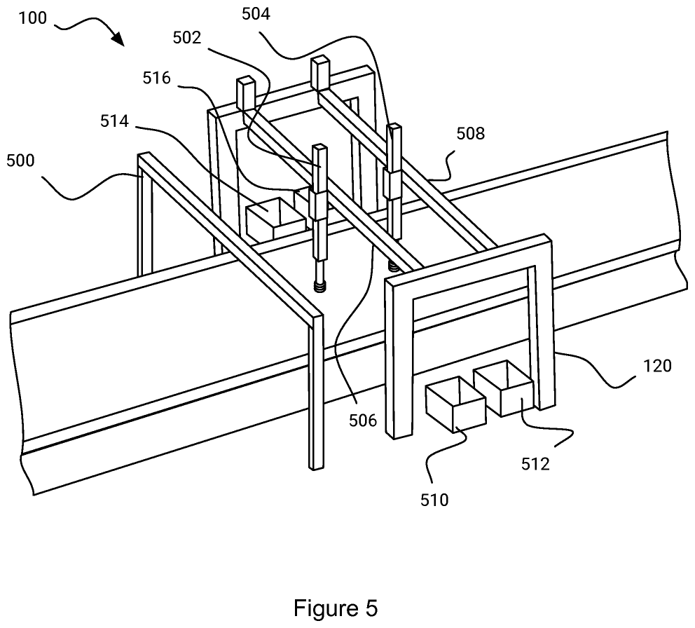

FIG. 5 shows a perspective view of a plurality of manipulators of the waste sorting robot according to an example;

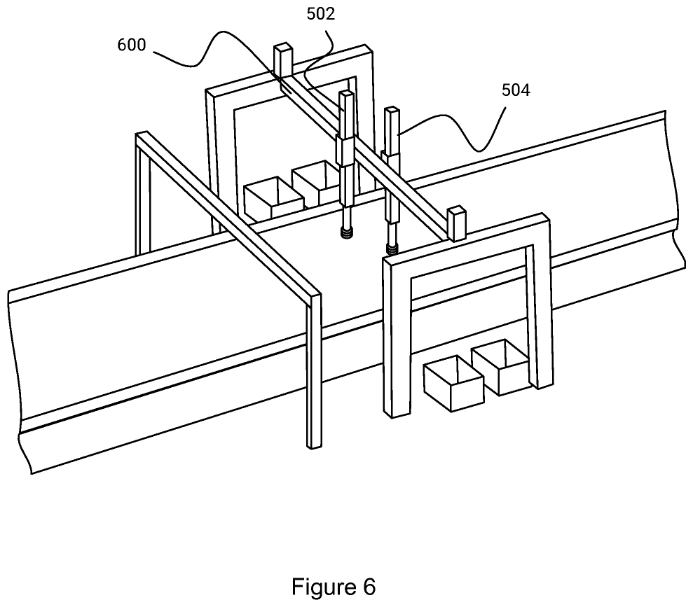

FIG. 6 shows another perspective view of a plurality of manipulators of the waste sorting robot according to an example;

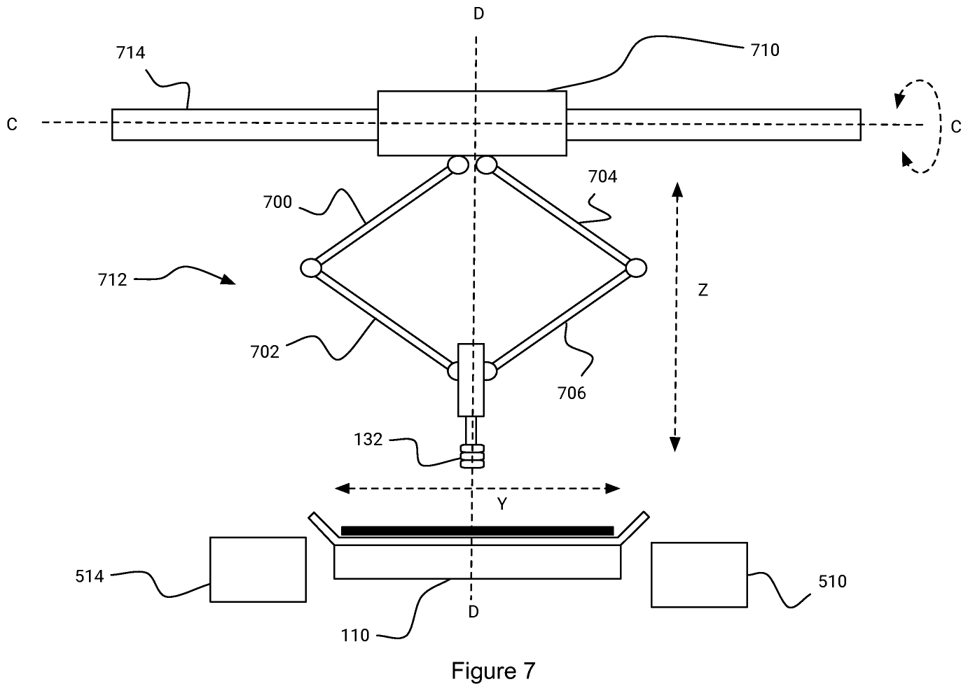

FIG. 7 shows a cross-sectional view of a manipulator of the waste sorting robot according to an example; and

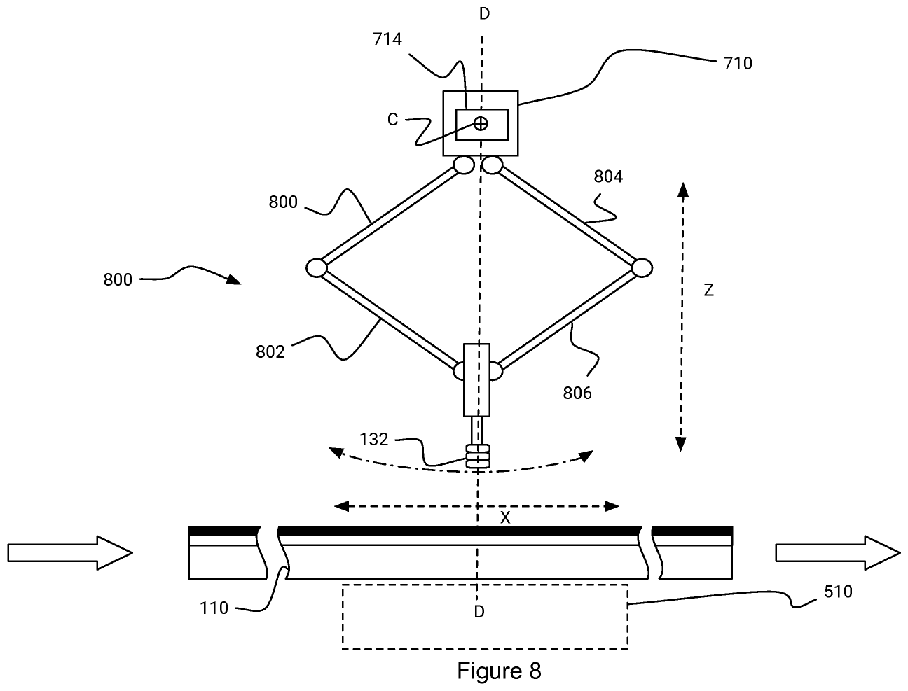

FIG. 8 shows a cross-sectional view of a manipulator of the waste sorting robot according to another example.

FIG. 1 shows a schematic perspective view of a waste sorting robot 100. In some examples, the waste sorting robot 100 can be a waste sorting gantry robot 100. In other examples other types of waste sorting robots can be used such as delta robots. For the purposes of brevity, the examples will be described in reference to waste sorting gantry robots but can also be other types of robot such as robot arms or delta robots. Alternatively, the waste sorting robot is a SCARA robot which has a rotary joint that moves the manipulator along the travelling direction of the belt.

For the purposes of brevity, the examples will be described in reference to waste sorting gantry robots 100, but any of the other aforementioned robot types can be used instead or in addition to the waste sorting gantry robot 100.

The waste sorting gantry robot comprises a controller 102 for sending control and movement instructions to a manipulator 104 for interacting with the physical objects 106a, 106b, 106c. The combination of a controller sending control instructions to a manipulator can also be referred to as a “robot”. The controller 102 is located remote from the manipulator 104 and is housed in a cabinet (not shown). In other examples, the controller 102 can be integral with the manipulator and/or a gantry frame 120.

The manipulator 104 physically engages and moves the objects 106a, 106b, 106c that enters the working area 108. The working area 108 of a manipulator 104 is an area within which the manipulator 104 is able to reach and interact with the object 106a 106b, 106c. The working area 108 as shown in FIG. 1 is projected onto a conveyor belt 110 for the purposes of clarity. The manipulator 104 is configured to move at variable heights above the working area 108. In this way, the manipulator 104 is configured to move within a working volume defined by the height above the working area 108 where the robot can manipulate an object. The manipulator 104 comprises one or more components for effecting relative movement with respect to the objects 106a, 106b, 106c. The manipulator 104 will be described in further detail below.

The physical objects 106a, 106b, 106c are moved into the working area 108 by the conveyor belt 110. The path of travel of the conveyor belt 110 intersects with at least a portion of the working area 108. In some examples, manipulator 104 can move over the entire working area 108. In other examples, the manipulator 104 can move through a portion of the working area 108 and a plurality of waste sorting robots 100 operate within the working area 108. For example, two waste sorting robots 100 can cover the entire conveyor belt 110. This means that every object 106a, 106b, 106c that is moving on the conveyor belt 110 will pass through the working area 108. The conveyor belt 110 can be a continuous belt, or a conveyor belt formed from overlapping portions. The conveyor belt 110 can be a single belt or alternatively a plurality of adjacent moving belts.

In other examples, the physical objects 106a, 106b, 106c can be conveyed into the working area 108 via other conveying means. The conveyor can be any suitable means for moving the objects 106a, 106b, 106c into the working area 108. For example, the objects 106a, 106b, 106c are fed under gravity via slide (not shown) to the working area 108. In other examples, the objects can be entrained in a fluid flow, such as air or water, which passes through the working area 108.

The direction of the conveyor belt 110 is shown in FIG. 1 by two arrows. The objects 106a, and 106b are representative of different types of objects to be sorted having not yet been physically engaged by the manipulator 104. In contrast, the object 106c is an object that has been sorted into a particular type of object. In some examples, the manipulator 104 interacts with only some of the objects 106c. For example, the waste sorting gantry robot 100 is only removing a particular type of object. In other scenarios, the manipulator 104 will interact and sort every object 106a, 106b, 106c which is on the conveyor belt 110.

In some examples, the objects to be sorted are waste products. The waste products can be any type of industrial, commercial, domestic waste or any other waste which requires sorting and processing. Unsorted waste material comprises a plurality of fractions of different types of waste. Industrial waste can comprise fractions, for example, of metal, wood, plastic, hardcore and one or more other types of waste. In other examples, the waste can comprise any number of different fractions of waste formed from any type or parameter of waste. The fractions can be further subdivided into more refined categories. For example, metal can be separated into steel, iron, aluminium etc. Domestic waste also comprises different fractions of waste such as plastic, paper, cardboard, metal, glass and/or organic waste.

A fraction is a category of waste that the waste can be sorted into by the waste sorting gantry robot 100. A fraction can be a standard or homogenous composition of material, such as aluminium, but alternatively a fraction can be a category of waste defined by a customer or user.

In some examples, the waste can be sorted according to any parameter. A non-limiting list of parameters for dividing unsorted waste into fractions is as follows: material, previous purpose, size, weight, colour, opacity, economic value, purity, combustibility, whether the objects are ferrous or any other variable associated with waste objects. In a further example, a fraction can comprise one or more other fractions. For example, one fraction can comprise a paper fraction, a cardboard fraction, and a wood fraction to be combinable to be a combustible fraction. In other examples, a fraction can be defined based on the previous purpose of the waste object, for example plastic tubes used for silicone sealant. It may be desirable to separate out some waste objects because they are contaminated and cannot be recycled.

The objects are fed from a hopper or other stored source of objects onto the conveyor belt 110. Alternatively, the waste objects are fed from another conveyor belt (not shown) and there is no source of stored waste objects. In this case, the additional conveyor belt can be fed manually from e.g. an excavator. Optionally, the objects 106a, 106b, 106c can be pre-processed before being placed on the conveyor belt. For example, the objects can be washed, screened, crushed, ripped, shaken, vibrated to prepare the material before sorting. Alternatively, the waste objects 106a, 106b, 106c can be sorted with another robot or mechanical device. The objects 106a, 106b, 106c can be optionally pre-sorted before being placed on the conveyor belt 110. For example, ferrous material can be removed from the unsorted waste by passing a magnet in proximity to the conveyor belt 110. Large objects can be broken down into pieces of material which are of a suitable size and weight to be gripped by the manipulator 104.

The manipulator 104 is configured to move within the working volume. The manipulator 104 comprises one or more drive mechanisms 112, 114, 116 for moving the manipulator 104 in one or more axes. The drive mechanisms 112, 114, 116 can be servos, pneumatic actuators, rack and pinion mechanisms, belt drives or any other suitable means for moving the manipulator 104 in one or more directions. In some examples, the manipulator 104 comprises one or more servos for moving the manipulator 104 in one or more axes. In some other examples, the manipulator 104 comprises one or more pneumatic actuators for moving the manipulator 104 in one or more axes. In some further examples, the manipulator 104 comprises a combination of one or more servos and one or more pneumatic actuators for moving the manipulator 104 in one or more axes. In some examples, the manipulator 104 is moveable along a plurality of axes.

In some examples, the manipulator 104 is moveable along three axes which are substantially at right angles to each other. For example as shown in FIG. 1, the manipulator 104 is movable in an X-axis which is parallel with the longitudinal axis of the conveyor belt 110 (“beltwise” or “lengthways”). Additionally, the manipulator 104 is movable across the conveyor belt 110 in a Y-axis which is perpendicular to the longitudinal axis of the conveyor belt 110 (“widthwise”). The manipulator 104 is also movable in a Z-axis which is in a direction normal to the working area 108 and the conveyor belt 110 (“heightwise”). Optionally, the manipulator 104 can rotate about one or more axes. In some examples a suction gripper 132 or other suitable gripper coupled to the manipulator 104 can rotate about a W-axis. The suction gripper 132 or other suitable gripper is discussed in further detail below.

The directions of movement of the manipulator 104 within the working space along the X-axis, Y-axis and the Z-axis are shown by the two headed arrows with dotted lines in FIG. 1. The manipulator 104 is moved with respect to the conveyor belt 110 by an X-axis drive mechanism 112, a Y-axis drive mechanism 114 and a Z-axis drive mechanism 116 respectively along the X-axis, the Y-axis and the Z-axis. The X-axis, Y-axis and Z-axis drive mechanisms 112, 114, 116 are connected to the controller 102 and the controller 102 is configured to issue instructions for actuating one or more X-axis, Y-axis and Z-axis drive mechanisms 112, 114, 116 to move the manipulator 104 within the working space 108. The connections between the X-axis, Y-axis and Z-axis drive mechanisms 112, 114, 116 and the controller 102 are represented by dotted lines. Each connection between the X-axis, Y-axis and Z-axis drive mechanisms 112, 114, 116 and the controller 102 can comprises one or more data and/or power connections.

The X-axis, Y-axis and Z-axis drive mechanisms 112, 114, 116 for moving the manipulator 104 will be discussed in further detail with respect to FIGS. 2 to 7.

As shown in FIG. 1, the manipulator 104 is mounted on a frame 120. In some examples, the frame 120 can be a gantry frame 120. In other examples, the frame 120 can be other structures suitable for supporting the manipulator 104 above the working area 108. For example, the frame 120 can be a structure for suspending the manipulator 104 above the working area 108 with rods and/or cables from a ceiling, wall or other structure. Hereinafter, the frame 120 will be referred to a gantry frame 120 but can be applicable to other frames for supporting the manipulator 104.

The gantry frame 120 comprises vertical struts 122 which engage with the floor or another substantially horizontal surface. In some examples, the vertical struts 122 can be tilted upright struts. In this way, the tilted upright struts are angled to the vertical. The tilted upright struts may be required to mount the gantry frame 120 to the floor in a non-standard installation. FIG. 1 shows the gantry frame 120 comprising four vertical struts 122 coupled together by horizontal beams 124. In other examples, the horizontal beams 124 can be tilted lateral beams 124. This may be required if the waste sorting gantry robot 100 is being installed in a small or unusual space. In other examples, there can be any suitable number of vertical struts 122. The beams 124 and struts 122 are fixed together with welds, bolts or other suitable fasteners. Whilst the horizontal beams 124 are shown in FIG. 1 to be located above the conveyor belt 110, one or more horizontal beams 124 can be positioned at different heights. For example, one or more horizontal beams 124 can be positioned underneath the conveyor belt 110. This can lower the centre of mass of the gantry frame 120 and make the entire waste sorting gantry robot 100 more stable if the vertical struts 122 are not secured to the floor.

The beams 124 and the struts 122 are load bearing and support the weight of the manipulator 104 and an object 106a, 106b, 106c that the manipulator 104 grasps. In some examples, the beams 124 and struts 122 are made from steel but other stiff, lightweight materials such as aluminium can be used. The vertical struts 122 can each comprise feet 126 comprising a plate through which bolts (not shown) can be threaded for securing the struts 122 to the floor. For the purposes of clarity, only one foot 126 is shown in FIG. 1, but each strut 122 can comprise a foot 126. In other examples, there are no feet 126 or fasteners for securing the gantry frame 120 to the floor. In this case, the gantry frame rests on the floor and the frictional forces between the gantry frame and the floor are sufficient to prevent the waste sorting gantry robot from moving with respect to the floor.

In some examples as shown in FIGS. 1 and 2, the horizontal beam 128 is fixed with respect to the gantry frame 120. This is in contrast to previously known waste sorting gantry robots because there is no servo mounted on the frame for moving the horizontal beam 128 in the X axis. Instead, the X-axis drive mechanism 112 for causing movement of the manipulator 104 in the X-axis is mounted to the horizontal beam 128 as discussed in reference to FIG. 2 below.

This means that the waste sorting gantry frame robot 100 only needs to provide a single horizontal beam 128 across the conveyor belt 110 reducing the weight and complexity of the waste sorting robot 100. This is because the gantry frame 120 of the waste sorting gantry frame robot 100 does not need to allow movement of the manipulator 104 mounted on a horizontal beam with an X-axis servo. By reducing the complexity of the gantry frame 120, this means that installation of the waste sorting gantry frame robot 120 on a picking line is simplified and can be achieved by a single person.

By using a suction gripper 132 which pivots with respect to the horizontal beam 128 (rather than using an X-axis servo to move the horizontal beam 128), the mass of the manipulator 104 can be greatly reduced. Movement of the horizontal beam 128 or the manipulator 104 can be achieved with a limited angular movement. This means the inertia of the manipulator 104 is reduced and the manipulator 104 can be accelerated more quickly. This means that the manipulator 104 can move faster and the speed of the conveyor belt 110 can be increased. Advantageously, by increasing the speed of the conveyor belt 110, the objects to be sorted on the conveyor belt 110 are more singularized and less likely to be overlapping. This means that the manipulation and object recognition is easier. This increases the processing rate (e.g. tons/hour) because the number of objects per hour which is fed to the robot increases.

This means that the waste sorting robot 100 is suitable for a working area 108 with a limited available distance in the X-axis but scalable in the Y-axis. Furthermore, the particular arrangement is advantageous for a waste sorting robot 100. This is because a high precision of movement of the manipulator 104 similar to conventional robotics (e.g. <1 mm) is not required. This is because the waste objects deform or move on the conveyor belt 110 and waste objects are successfully picked with the waste sorting robot discussed in reference to the Figures. Accordingly simple and lightweight materials can be used which provide a manipulator 104 that is faster moving than conventional waste sorting gantry robots. The lightweight materials of the waste sorting robot 100 are advantageously low cost.

Since the waste sorting robot 100 takes up a small space along the conveyor belt 110 in the Y-axis direction, a large work volume can be achieved with multiple waste sorting robots 100 sequentially positioned along the conveyor belt 110.

However, additionally or alternatively, the manipulator 104 optionally comprises at least one movable horizontal beam 128 which is movably mounted on the gantry frame 120. The moveable beam 128 can be mounted in a beam carriage (not shown). The moveable horizontal beam 128 is movably mounted on one or more of the other fixed horizontal beams 124 of the gantry frame 120.

For example, the horizontal beam 128 is optionally rotatable about the longitudinal axis (A-A) of the horizontal beam 128. In this way, when the horizontal beam 128 rotates, the manipulator 104 moves in the X axis. This is discussed in further detail with respect to FIGS. 4 and 7.

Turning back to FIG. 2, the example of at least part of the manipulator 104 being pivotally mounted on the horizontal beam 128 will be discussed in further detail. The manipulator 104 is coupled via a manipulator carriage 130 to a fixed horizontal beam 128. The manipulator carriage 130 is coupled to a gripper assembly 132 for picking the waste objects 106a, 106b, 106c. The manipulator carriage 130 is moveable along the longitudinal axis of the horizontal beam 128.

Movement of the manipulator 104 in the Y-axis and Z-axis will now be discussed in further detail with reference to FIGS. 1 and 2. Movement of the manipulator in the X-axis will be discussed in further detail below. The manipulator carriage 130 is movable in the Y-axis relative to the horizontal beam 128. In some examples, the manipulator carriage 130 comprises a Y-axis drive mechanism 114 for moving the manipulator carriage 130 along the Y-axis. In some examples, the Y-axis drive mechanism 114 is a servo.

In other examples, the Y-axis drive mechanism 114 is not mounted in the manipulator carriage 130 and manipulator carriage 130 moves with respect to the Y-axis drive mechanism 114. In some examples, the Y-axis drive mechanism 114 is coupled to the horizontal beam 128 via a belt drive. In other examples, the Y-axis drive mechanism 114 is a servo which is coupled to the horizontal beam 128 via a rack and pinion mechanism. In some examples, other mechanisms can be used to actuate movement of the horizontal beam 128 along the Y-axis. For example, a hydraulic or pneumatic system can be used for moving the manipulator carriage 130.

When the manipulator carriage 130 moves along the Y-axis, the suction gripper 132 also moves in the Y-axis. The suction gripper 132 is movably mounted to the manipulator carriage 130. The suction gripper 132 is movable in the Z-axis in order to move the manipulator 104 heightwise in the Z-axis direction.

In some examples, the suction gripper 132 comprises a Z-axis drive mechanism 116 for moving the suction gripper 132 along the Z-axis. In some examples, the Z-axis drive mechanism is a pneumatic actuator 116. In other examples, the Z-axis drive mechanism 116 is a Z-axis servo. Accordingly, when the Z-axis drive mechanism 116 is actuated and extends the suction gripper 132, the suction gripper 132 moves towards the conveyor belt 110.

FIGS. 1 and 2 show an example suction gripper 132 which will now be discussed. The suction gripper 132 can be a suction gripper having a suction cup 200 for gripping the objects using negative pressure with respect to atmospheric pressure. The suction gripper 132 is part of a suction gripper assembly 132 comprising one or more components for actuating or moving the suction gripper 132. For the purposes of clarity, reference will only be made to the suction gripper 132. The suction gripper 132 can have a suction cup (212 in FIG. 2) which is substantially symmetric about the Z-axis.

This means that the suction gripper 132 does not need to be rotated about the Z-axis to achieve an optimal orientation with respect to the objects 106a, 106b, 106c. This means that the gripper assembly rotation servo is not required with a suction gripper 132. In the case with an asymmetrical suction gripper 132, the suction gripper 132 comprises a rotation servo or other actuator such as a pneumatic actuator (not shown) to rotate the suction gripper 132 about the W-axis as previously discussed above. Rotation of the suction gripper 132 about the W-axis is shown in FIG. 1, but the servo for causing the rotation is not shown. The suction gripper 132 can have an elongate suction cup 212. Additionally or alternatively, the suction gripper 132 can comprise a plurality of suction grippers. For example, the suction gripper 132 can comprise an asymmetrical suction gripper 132 comprising two suction tubes each with a suction cup.

In other examples, the suction gripper 132 of the manipulator 104 additionally or alternatively comprises any suitable means for physically engaging and moving the objects 106a, 106b, 106c. Indeed, the manipulator 104 can additionally or alternatively be one or more tools for grasping, securing, gripping, cutting or skewering objects. For example, the gripper assembly 132 is a pair of gripping jaws, a finger gripper or any magic gripper. In this way, the manipulator 104 can comprise a gripper which is not a suction gripper. In further examples the manipulator 104 can additionally be a tool configured for interacting with and moving an object at a distance such as an electromagnet or a nozzle for blowing compressed air.

As mentioned previously, the controller 102 is configured to send instructions to the X-axis, Y-axis and Z-axis drive mechanisms 112, 114, 116 of the manipulator 104 to control and interact with objects 106a, 106b, 106c on the conveyor belt 110. The controller 102 is connected to at least one sensor 134 for detecting the objects 106a, 106b, 106c on the conveyor belt 110. The at least one sensor 134 is positioned in front of the manipulator 104 so that detected measurements of the objects 106a, 106b, 106c are sent to the controller 102 before the objects 106a, 106b, 106c enter the working area 108. In some examples, the at least one sensor 134 can be one or more of a RGB camera, an infrared camera, a metal detector, a hall sensor, a temperature sensor, visual and/or infrared spectroscopic detector, 3D imaging sensor, terahertz imaging system, radioactivity sensor and/or a laser. The at least one sensor 134 can be any sensor suitable for determining a parameter of the object 106a, 106b, 106c.

FIG. 1 shows that the at least one sensor 134 is positioned in one position. The at least one sensor 134 is mounted in a sensor housing 136 to protect the sensor 134. In other examples, a plurality of sensors are positions along and around the conveyor belt 110 to receive parameter data of the objects 106a, 106b, 106c. In some examples, the at least one sensor 134 is mounted in a sensor bar 500 (as shown in FIG. 5) which is positioned in front of the manipulator 104 on the conveyor belt 110. In this way, the sensor bar 500 detects the objects 106a, 106b, 106c to be sorted before the objects 106a, 106b, 106c enter the working area 108.

The controller 102 receives information from the at least one sensor 134 corresponding to one or more objects 106a, 106b, 106c on the conveyor belt 110. The controller 102 determines instructions for moving the manipulator 104 based on the received information according to one or more criteria. Various information processing techniques can be adopted by the controller 102 for controlling the manipulator 104. Such information processing techniques are described in WO2012/089928, WO2012/052615, WO2011/161304, WO2008/102052 which are incorporated herein by reference. The control of the waste sorting robot 100 is discussed in further detail in reference to FIG. 3 below.

Once the manipulator 104 has received instructions from the controller 102, the manipulator 104 executes the commands and moves the suction gripper 132 to pick an object 106c from the conveyor belt 110. The process of selecting and manipulating an object on the conveyor belt 110 is known as a “pick”.

Once a pick has been completed, the manipulator 104 drops or throws the object 106c into a chute 138. An object 106c dropped into the chute 138 is considered to be a successful pick. A successful pick is one where an object 106c was selected and moved to the chute 138 associated with the same fraction of waste as the object 106c.

The chute 138 comprises a chute opening 142 in the working area 108 for dropping picked objects 106c. The chute opening 142 of the chute 138 is adjacent to the conveyor belt 110 so that the manipulator 104 does not have to travel far when conveying a picked object 106c from the conveyor belt 110 to the chute opening 142. By positioning the chute opening 142 of the chute adjacent to the conveyor belt 110, the manipulator 104 can throw, drop, pull and/or push the object 106c into the chute 138.

The chute 138 comprises walls 140 defining a conduit for guiding picked objects 106c into a fraction receptacle (not shown) for receiving a sorted fraction of waste. In some examples, a fraction receptacle is not required and the sorted fractions of waste are piled up beneath the chute 138. FIG. 1 only shows one chute 138 associated with the manipulator 104. In other examples, there can be a plurality of chutes 138 and associated openings 142 located around the conveyor belt 110. Each opening 142 of the different chutes 138 is located within the working area 108 of the manipulator 104. The walls 140 of the conduit can be any shape, size or orientation to guide picked objects 106c to the fraction receptacle. In some examples, the successfully picked objects 106c move under the force of gravity from the chute opening 142 of the chute 138 to the fraction receptacle. In other examples, the chute 138 may guide the successfully picked objects 106c to another conveyor belt (not shown) or other means for moving the successfully picked objects 106c to the fraction receptacle.

Turning back to FIG. 2, the movement of the manipulator 104 in the X-axis will be discussed in further detail. FIG. 2 shows a close-up perspective schematic view of a manipulator of the waste sorting robot according to an example. The movement of the manipulator 104 in the orthogonal X-axis, Y-axis, Z-axis is illustrated with two headed arrows in FIG. 2.

The working area 108 has been indicated with a rectangle with a dotted line. The conveyor belt 110 has not been shown in FIG. 2 for the purposes of clarity.

The manipulator 104 comprises a manipulator carriage 130 which is slidably moveable on the horizontal beam 128. The manipulator carriage 130 and the horizontal beam 128 is the same as discussed with reference to FIG. 1. Movement of the manipulator carriage 130 causes movement of the manipulator 104 in the Y-axis as previously discussed.

The manipulator 104 is rotatable with respect to the horizontal beam 128. The manipulator 104 is arranged to rotate within a plane substantially perpendicular to the plane of the conveyor belt 110. This is illustrated in FIG. 2 with the arc 200 showing the limits of the movement of the manipulator 104.

In some examples, at least a portion of the manipulator 104 is pivotally mounted on the manipulator carriage 130. The manipulator carriage 130 comprises a yoke 202 having a first arm 204 and a second arm 206. The yoke 202 provides a pivot point 208 for a pin (not shown) which is threaded through an upper portion 210 of the suction gripper 132. The pivot point 208 allows the suction gripper 132 to pivot about the axis B-B. The axis B-B is substantially parallel with the horizontal beam 128.

In other examples the axis B-B is not parallel with the horizontal beam 128. This means that pivoting of the manipulator 104 about the axis B-B will cause movement of the suction gripper 132 in both the X-axis and the Y-axis.

In some examples, the manipulator 104 is pivotally mounted directly on the horizontal beam 128 and there is no manipulator carriage 130. In this case, the horizontal beam 128 is moveable with respect to the frame 120 and the horizontal beam 128 slides along the longitudinal axis A-A of the horizontal beam 128 in order to cause the manipulator 104 to move in the Y-axis.

The upper portion 210 of the suction gripper 132 comprises a Z-axis pneumatic actuator 116 (not shown in FIG. 2 for the purposes of clarity) for moving the lower portion 214 of the suction gripper 132 in the Z-axis. In this way, the Z-axis pneumatic actuation 116 adjusts the height of the suction cup 212 above the conveyor belt 110 as previously discussed.

An X-axis drive mechanism 112 is coupled between the manipulator carriage 130 and the upper portion 210 of the suction gripper 132. In some examples, the X-axis drive mechanism 112 is a first pneumatic actuator 306. In other examples, the X-axis drive mechanism 112 can be any suitable mechanism for causing the suction gripper 132 to pivot about the horizontal beam 128 such as a linkage or a rack and pinion mechanism.

This means that the suction gripper 132 can be moved in the X-axis by extension or retraction of the first pneumatic actuator 306 which causes rotation about the B-B axis. The extension/retraction of the first pneumatic actuator 306 causes at least a portion of the manipulator 104 to pivot about the B-B axis. Accordingly, the suction gripper 132 moves in an arc 200 which moves the suction gripper 132 in the X-axis lengthways along the conveyor within the working area 108. The arc 200 of travel of the suction gripper 132 is shown in FIG. 2.

The suction gripper 132 will rotate about the B-B axis however this does not affect the functionality of the suction gripper 132 because the rotation of the suction gripper 132 with respect to the conveyor belt 110 is not particularly great. Furthermore, the suction cup 212 is flexible to compensate for the irregular shapes of the waste objects 106a, 106b, 106c on the conveyor. Therefore, the suction cup 212 can still pick objects 106a, 106b, 106c on the conveyor 110 even when the manipulator 104 is rotated about the axis B-B. In some examples, the suction gripper 132 rotates about the B-B axis with a rotation between 10 to 20 degrees. This allows the suction gripper 132 to successfully pick waste objects within the working area 108 whilst not requiring the manipulator 104 or the suction gripper 132 to be separately rotated to be exactly vertical. Advantageously, this means that the manipulator 104 can remain lightweight and not require additional actuators and linkages to ensure that the suction gripper 132 remains vertical.

In some alternative examples, the manipulator 104 comprises further articulations in addition to the pivot point 208. For example, the manipulator 104 comprises two or three pivotable joints. In this case, the suction gripper 132 can be kept vertical. For each additional articulation, an additional pneumatic cylinder is provided.

Advantageously, this means that the waste sorting gantry frame robot 100 only needs to provide a single horizontal beam 128 across the conveyor belt 110 reducing the weight and complexity of the waste sorting robot 100. This is because the gantry frame 120 of the waste sorting gantry frame robot 100 does not need to allow movement of the manipulator 104 mounted on a horizontal beam with an X-axis servo. By reducing the complexity of the gantry frame 120, this means that installation of the waste sorting gantry frame robot 120 on a picking line is simplified and can be achieved by a single person.

Advantageously, by using a suction gripper 132 which pivots with respect to the horizontal beam 128 (rather than using an X-axis servo to move the horizontal beam 128), the mass of the manipulator 104 can be greatly reduced. This means the inertia of the manipulator 104 is reduced and the manipulator 104 can be accelerated quickly. This means that the manipulator 104 can move faster and the speed of the conveyor belt 110 can be increased.

Advantageously, by increasing the speed of the conveyor belt 110, the objects to be sorted on the conveyor belt 110 are more singularized and less likely to be overlapping. This means that the manipulation and object recognition is easier. This increases the processing rate (e.g. tons/hour) because the number of objects per hour which is fed to the robot increases.

The control of the waste sorting robot 100 will now be discussed in further detail with reference to FIG. 3. FIG. 3 shows a schematic view of the waste sorting robot 100 and manipulator 104 according to an example discussed in reference to any of the other examples.

As mentioned, the X-axis drive mechanism 112 and the Z-axis drive mechanism 116 respectively comprise first and second pneumatic actuators 306, 308 for respectively causing the movement of the manipulator 104 in the X-axis and Z-axis. By using the first and second pneumatic actuators 306, 308 to move the manipulator 104, the waste sorting robot 100 can be made lighter than compared to a waste sorting robot 100 using servos for moving the manipulator 104. Again this reduces the mass and inertia of the manipulator 104 and can increase the speed of the waste sorting robot 100.

FIG. 3 shows a suction gripper 132 which is in fluid communication with a pneumatic system 300. The pneumatic system 300 comprises at least one hose 304 for connecting the suction gripper 132 to the pneumatic system 300. In some embodiments, the hose is an air hose 304 for providing a source of air to the suction gripper 132.

Furthermore, the first pneumatic actuator 306 is in fluid communication with the pneumatic system 300. The pneumatic system 300 comprises at least one hose 310 for connecting the first pneumatic actuator 306 to the pneumatic system 300. Likewise, the second pneumatic actuator 308 is in fluid communication with the pneumatic system 300. The pneumatic system 300 comprises at least one hose 310 for connecting the second pneumatic actuator 306 to the pneumatic system 300.

The air hoses 304, 310, 312 are flexible and threaded along the horizontal beam 128 and connected to pneumatic system 300. In some embodiments, (not shown) the air hoses 304, 310, 312 can be inserted within the hollow horizontal beam 128. The hoses 304, 310, 312 are sufficiently flexible to move and flex so as to change shape as the manipulator 104 moves without impeding the movement of the manipulator 104.

The pneumatic system 300 can comprise an air compressor for generating a source of compressed air. Optionally, the pneumatic system 300 can also comprise an air storage tank (not shown) for compressed air. Furthermore, the pneumatic system 300 can also comprise one or more valves 302 for selectively providing air to the suction gripper 132, the first pneumatic actuator 306, and/or the second pneumatic actuator 308. In some embodiments, the air compressor generates an air source having a pressure of 8 Bar. In other embodiments, the air source has a pressure of 5 Bar to 10 Bar. In other embodiments, the air source can have any suitable pressure above atmospheric pressure.

The pneumatic system 300 can be partially or wholly located remote from the waste sorting robot 100. For example, there may be a plurality of waste sorting robots 100 on a sorting line (not shown) each of which require a source of air. In this way, a single air compressor can be connected to a plurality of waste sorting robots 100 via a plurality of air hoses 304, 310, 312.

Accordingly, the pneumatic system 300 may be located between waste sorting robots 100.

In some examples, waste sorting robot 100 comprises a suction gripper sensor 314 for detecting relative movement of the suction gripper 132 or the manipulator 104 in the X-axis. The suction gripper sensor 314 is mounted on the suction gripper 132, or the manipulator 104 and connected to the controller 102. In this way, the suction gripper sensor 314 is configured to detect the rotational movement of the suction gripper 132 as the suction gripper 132 pivots about the axis B-B in FIG. 2. Alternatively, the suction gripper sensor 314 is configured to detect the rotational movement of the moveable horizontal beam 128 about the A-A axis as shown in FIG. 4. The example as shown in FIG. 4 will be discussed in further detail below.

In some examples, the suction gripper sensor 314 is a gyroscopic sensor, such as an electrical MEMS gyroscope is used as a velocity sensor. This means that the controller 102 can determine the velocity of the suction gripper 132 during operation in order to make the control of the suction gripper 132 more accurate. Additionally or alternatively, the first pneumatic actuator 306 of the X-axis drive mechanism 112 and/or the second pneumatic actuator 308 of the Z-axis drive mechanism 116 comprise first and second pressure sensors 316, 318. The first and second pressure sensors 316, 318 are mounted to the first and second pneumatic actuators 306, 308 such that the signal generated by the first and second pressure sensors 316, 318 indicates the extension of the first and second pneumatic actuators 306, 308. The pressure sensors 316, 318 are connected to the controller 102. Accordingly the controller 102 can determine the status of the first and second pneumatic actuators 306, 308.

The signals received from the suction gripper sensor 314, and the first and second pressure sensors 316, 318 are used as linear terms in the proportional integral derivative (PID) controller algorithm of the manipulator 104.

FIG. 3 shows a schematic cross section of the waste sorting gantry robot 100. Operation of the pneumatic system 300 is controlled by the controller 102. This means that the controller 102 can selectively operate e.g. the air compressor or the valve 302 of the pneumatic system 300 to deliver a supply of air to the suction gripper 132, the first pneumatic actuator 306 and/or the second pneumatic actuator 308. In this way, the first pneumatic actuator 306, the second pneumatic actuator 308 and/or the suction gripper 132 are connected to a single pneumatic system 300.

During operation, the controller 102 controls the first pneumatic actuator 306 and/or the second pneumatic actuator 308 in order to move the suction gripper 132 in the Z-axis and rotate the suction gripper 132 about the B-B axis.

Movement of the first pneumatic actuator 306 and the amount of rotation of the suction gripper 132 about B-B axis is based on the position determined from signals received from one or more of the suction gripper sensor 314, and the first and second pressure sensors 316, 318. Accordingly, the controller 102 positions the suction gripper 132 in the X-axis having moved the suction gripper 132 in the Z-axis and rotated the suction gripper 132 about the B-B axis.

The controller 102 can detect if the suction gripper 132 touches an object 106a, 106b, 106c above the conveyor belt 110. This means that the controller 102 can dynamically adjust the amount of rotation about the B-B axis and/or the amount of movement in the Z-axis so that the suction gripper 132 does not drag the object 106a, 106b, 106c along the conveyor belt 110. In other words, the controller 102 can control the movement of the suction gripper 132 in the Z-axis and rotate the suction gripper 132 about the B-B axis to maintain the suction gripper 132 at a determined height above the conveyor belt 110 and not at the surface of the conveyor belt 110.

Turning to FIG. 4 another example will now be described. FIG. 4 shows another close-up perspective schematic view of the manipulator 104 of the waste sorting robot according to an example. FIG. 4 is the same as the waste sorting robot 100 as shown in FIG. 2 except that the manipulator 104 does not rotate with respect to the horizontal beam 128. The upper portion 210 of the suction gripper 132 is fixed to the manipulator carriage 130. In this way, the suction gripper 132 does not pivot about the manipulator carriage 130.

In contrast, the horizontal beam 128 is moveable and rotates about the longitudinal axis A-A of the horizontal beam 128. This means that the manipulator 104 rotates about the axis A-A at the same time as the horizontal beam 128. The manipulator carriage 130 is slidably mounted on the horizontal beam 128 but the manipulator carriage 130 is only permitted to slide along the horizontal beam 128. Accordingly, there is no relative movement between the manipulator 104 and the horizontal beam 128 when the horizontal beam 128 rotates.

Similar to the example as discussed in reference to FIG. 2, when the horizontal beam 128 rotates, the suction gripper 132 and the suction cup 212 move along the X-axis.

The horizontal beam 128 is coupled to an X-axis drive mechanism 112 for rotating the horizontal beam 128 about the axis A-A. The X-axis drive mechanism 112 is a servo coupled to horizontal beam 128. Alternatively, the horizontal beam 128 can be pivotally coupled to a pneumatic actuator (not shown). The X-axis drive mechanism 112 can be any suitable mechanism for causing the horizontal beam 128 to rotate. This is advantageous because the manipulator 104 can be made lighter since the pneumatic actuator is not mounted on the moving manipulator carriage 130. The inertia of rotation of the horizontal beam 128 and the manipulator 104 does not increase significantly.

FIG. 5 shows a perspective view of a plurality of manipulators 502, 504 of the waste sorting robot 100 according to an example. The manipulators 502, 504 are the same as the manipulators 104 described in the examples in reference to any of the Figures. The manipulators 502, 504 are respectively mounted on horizontal beams 506, 508. The horizontal beams 506, 508 are mounted to the gantry frame 120. Since the manipulators 502, 504 are lighter and less bulky, they can be positioned closer together within the same gantry frame 120 without the manipulators 502, 504 colliding. This means that the manipulators 502, 504 can sort objects 106a, 106b, 106c in the same chutes, 510, 512, 514, 516. FIG. 5 shows that there are two chutes each side of the conveyor belt 110. In other examples, there are between one and three chutes on each side of the conveyor belt 110. In this way, each manipulator 502, 504 can feed sorted objects 106c into two chutes on each side of the conveyor belt 110. In some examples, the working areas 108 of the manipulators 502, 504 can overlap, however, the controller 102 instructs the manipulators 502, 504 not to collide in the X-axis.

In further embodiments, there can be any number of manipulators 502, 504 positioned along the conveyor belt 110.

FIG. 6 shows another perspective view of a plurality of manipulators 502, 504 of the waste sorting robot according to an example. The example shown in FIG. 6 is the same as shown in FIG. 5 except that the manipulators 502, 504 are mounted on the same horizontal beam 600.

FIG. 7 shows a cross-sectional view of a manipulator 712 of the waste sorting robot 100 according to an example. The manipulator 712 comprises a plurality of pivoting linkages 700, 702, 704, 706 connected between the suction gripper 132 and the frame 710. Actuation of the pivoting linkages 700, 702, 704, 706 is achieved via one or more pneumatic actuators (not shown). Movement of the pivoting linkages 700, 702, 704, 706 causes movement of the suction gripper 132 in both the Z and Y directions. In this way, the assembly of pivoting linkages 700, 702, 704, 706 is analogous to a two-dimensional delta robot.

The pivoting linkages 700, 702, 704, 706 are pivotally mounted to a frame 710. The frame 710 is rotatable about an axis C-C. In some examples, the frame 710 is fixed to a rotating beam 714 which rotates in a similar way to the horizontal beam 128 described in FIG. 4. However, in some examples, the frame 710 is fixed to a wall or ceiling or another structure and the pivoting linkages 700, 702, 704, 706 pivot with respect to the frame 710 about axis C-C.

This means that when the pivoting linkages 700, 702, 704, 706 pivot with respect to the frame 710 or the frame 710 is rotates about axis C-C, the suction gripper 132 moves in the X-axis through the line D-D.

Another example will be discussed in reference to FIG. 8. FIG. 8 shows a cross-sectional view of a manipulator 800 of the waste sorting robot 100 according to an example. FIG. 8 shows a cross-section perpendicular to the cross-section shown in FIG. 7. The waste sorting robot 100 as shown in FIG. 8 is the same as the waste sorting robot 100 shown in FIG. 7 except that the pivoting linkages 800, 802, 804, 806 in FIG. 8 are arranged to move the suction gripper 132 in a perpendicular plane to the pivoting linkages 700, 702, 704, 706 in FIG. 7.

The manipulator 800 comprises a plurality of pivoting linkages 800, 802, 804, 806 connected between the suction gripper 132 and the frame 710. Actuation of the pivoting linkages 800, 802, 804, 806 is achieved via one or more pneumatic actuators (not shown) and is the same as discussed in reference to FIG. 7. Movement of the pivoting linkages 800, 802, 804, 806 causes movement of the suction gripper 132 in both the Z and X directions. In this way, the assembly of pivoting linkages 800, 802, 804, 806 is analogous to a two-dimensional delta robot. The example as shown in FIG. 8 is the same as shown in FIG. 7, except that the pivoting linkages 800, 802, 804, 806 move in the plane comprising the X-axis and the Z-axis.

In contrast, the pivoting linkages 700, 702, 704, 706 described in FIG. 7 move in the plane comprising the Y-axis and the Z-axis.

The pivoting linkages 800, 802, 804, 806 are pivotally mounted to a frame 710. The manipulator 800 is moveable along the longitudinal axis C-C of the beam 814 in the same way as described in reference to FIGS. 2 to 4.

This means that when the pivoting linkages 800, 802, 804, 806 pivot with respect to the frame 710, the suction gripper 132 moves in the X-axis along the length of the conveyor belt 110 within the working area 108.

In other examples, the suction gripper arrangements and the operation of the suction grippers as discussed can also be used with other types of object manipulation robots. For example, the suction gripper 132 can be used with industrial robots in the automotive industry, food industry etc. In this the way the suction gripper and method of controlling the manipulator and suction gripper can be used with a sorting robot for sorting objects.

Optionally, in another example the moveable horizontal beam 128 is additionally movable in the X-axis such that the manipulator 104 moves in the X-axis when the movable horizontal beam moves in the X-axis similar to previously known gantry frame robots. The moveable horizontal beam 128 is mounted to the fixed horizontal beams 124 via an X-axis servo mechanism 112. In some examples, the drive mechanism 112 is coupled to the moveable horizontal beam 128 via a belt drive. In other examples, the servo is coupled to the moveable horizontal beam 128 via a rack and pinion mechanism. In some examples, other mechanisms can be used to actuate movement of the moveable horizontal beam along the X-axis. For example, a hydraulic or pneumatic system can be used for moving the movable horizontal beam 128. In this way, there are two different X-axis drive mechanisms 112 for moving the manipulator 104 in the X-axis. This example may be less preferred because one of the X-axis drive mechanisms 112 may be redundant.

In another example, two or more examples are combined. Features of one example can be combined with features of other examples.

Examples of the present invention have been discussed with particular reference to the examples illustrated. However it will be appreciated that variations and modifications may be made to the examples described within the scope of the invention.

1. A waste sorting robot comprising:
a frame;
a manipulator moveably mounted to the frame and comprising a gripper for interacting with one or more waste objects to be sorted within a working area; and
a conveyor for moving the one or more waste objects towards the working area;
wherein at least a portion of the manipulator is rotatable with respect to the frame such that the gripper is moveable lengthways along the conveyor within the working area.

2. A waste sorting robot according to claim 1 wherein the portion of the manipulator is rotatable about a horizontal axis perpendicular to the longitudinal axis of the conveyor and the manipulator is moveably mounted on a cross beam over the conveyor and the manipulator is slidable along the cross beam.

3. A waste sorting robot according to claim 2 wherein the waste sorting robot comprises a servo for moving the manipulator along the cross beam.

4. A waste sorting robot according to claim 1, wherein the portion of the manipulator is pivotable with respect to the cross beam.

5. A waste sorting robot according to claim 1, wherein the portion of the manipulator is pivotally coupled to a carriage mounted to the cross beam.

6. A waste sorting robot according to claim 5, wherein a first pneumatic actuator is coupled to the portion of the manipulator and configured to rotate the portion of the manipulator with respect to the frame.

7. A waste sorting robot according to claim 6, wherein the first pneumatic actuator is coupled between the portion of the manipulator and the carriage.

8. A waste sorting robot according to claim 1, wherein a second pneumatic actuator is coupled to the gripper and configured to adjust the height of the gripper above the conveyor.

9. A waste sorting robot according to claim 1, wherein the gripper is a suction gripper.

10. A waste sorting robot according to claim 6 wherein the first pneumatic actuator, a second pneumatic actuator and/or the suction gripper are connected to a single pneumatic control system.

11. A waste sorting robot according to claim 1 wherein the manipulator and the cross beam rotate together.

12. A waste sorting robot according to claim 1, wherein the waste sorting robot comprises a plurality of manipulators rotatable with respect to the frame such that a grippers associated with each manipulator is moveable lengthways along the conveyor.

13. A waste sorting robot according to claim 12 wherein the plurality of manipulators are located along the length of the conveyor.

14. A waste sorting robot according to claim 12, wherein the plurality of manipulators are mounted on the same cross beam or the same frame.

15. A waste sorting robot according to claim 1, wherein the manipulator comprises an articulated arm with one or more pivoting joints.

16. A waste sorting robot according to claims 15 wherein each pivoting joint coupled to an associated actuator.

17. A waste sorting robot according to claim 15, wherein the manipulator comprises a plurality of linked articulated arms.

18. A waste sorting robot according to claim 1, wherein the waste sorting robot is a waste sorting gantry robot.

19. A waste sorting robot according to claim 1, wherein the frame comprises a cross-beam with a longitudinal axis and the longitudinal axis of the cross-beam is fixed with respect to the working area.

20. A waste sorting robot according to claim 1, wherein the manipulator comprises at least one pneumatic actuator coupled to the manipulator and/or the gripper configured to adjust the height of the gripper with respect to the working area.

21. A waste sorting robot according to claim 1, wherein the manipulator and/or the gripper are slidable in a direction perpendicular to the working area to adjust the height of the gripper with respect to the working area.

22. A waste sorting robot according to claim 1, wherein the manipulator comprises at least one pneumatic actuator coupled to the manipulator configured to slide the manipulator on the frame across the conveyor in the working area.

23. A method of controlling a waste sorting robot having a frame, a manipulator moveably mounted to the frame, and a gripper for interacting with one or more waste objects to be sorted within a working area, the method comprising:
moving the one or more waste objects towards the working area with a conveyor; and
rotating at least a portion of the manipulator with respect to the frame such that the gripper is moved lengthways along the conveyor within the working area.

24. (canceled)

25. A waste sorting robot comprising:
a frame;
a manipulator moveably mounted to the frame and comprising a gripper for interacting with one or more waste objects to be sorted within a working area; and
a conveyor for moving the one or more waste objects towards the working area;
characterised in that the frame comprises a fixed cross beam arranged over the conveyor and the manipulator is slidable along the cross-beam;
wherein at least a portion of the manipulator is rotatable with respect to a longitudinal axis of the cross beam perpendicular to a longitudinal axis of the conveyor such that the gripper is moveable lengthways along the longitudinal axis of the conveyor within the working area.
